(19) United States
(12) Patent Application Publication
(10) Pub. No.: US 2004/0226362 A1
(43) Pub. Date: Nov. 18, 2004

(54) Device for measuring a level of fluid in a container

(76) Inventors: Klaus Marx, Stuttgart (DE); Stefan Muelders, Ditzingen-Heimerdingen (DE); Reinhard Omet, Babenhausen (DE); Reiner Kaun, Hanau (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/803,984

(22) Filed: Mar. 19, 2004

(30) Foreign Application Priority Data
Mar. 19, 2003 (DE) 1 03 12 100.5

(51) Int. Cl. G01F 23/296

(52) U.S. Cl. 73/290 V

(57) ABSTRACT

A device for measuring a level of a fluid in a container by measuring the transit time of an emitted acoustic pulse to the fluid surface and of its return echo through a guide conduit. The transit time of the emitted acoustic pulse is prolonged so that the transit time is long enough to reliably separate the emitted decaying acoustic pulse from its echo. An approach region with a subsequent bend is provided in the acoustic guide conduit.

### BACKGROUND OF THE INVENTION

1. Field of the Invention

The invention is directed to an improved device for measuring a fluid level.

2. Description of the Prior Art

A device for measuring a fluid level is known from DE 199 42 378 A1, in which an ultrasonic transducer is disposed outside a fuel tank, close to one end of an acoustic guide conduit that is provided between a container bottom and the wall of a cover. The ultrasonic transducer transmits ultrasonic waves into the acoustic guide conduit and the ultrasonic waves are reflected against a fluid level. The reflected ultrasonic waves are received by the ultrasonic transducer and are evaluated in an evaluation unit. A fluid level is determined based on a transit time of the ultrasonic waves. The disadvantage to this is that a low fluid level close to the container bottom can no longer be measured since at a low fluid level, the transit time of the transmitted ultrasonic wave is so short that the transmitted ultrasonic wave has not yet decayed before the reflected ultrasonic wave has already returned. The device consequently has a relatively high minimum measurable fluid level.

### OBJECT AND SUMMARY OF THE INVENTION

The device for measuring a fluid level according to the invention has the advantage over the prior art that it represents an improvement by reducing the minimum measurable fluid level in comparison to the prior art through the simple addition of a horizontally extending approach region close to the container bottom at the end of an acoustic guide conduit oriented toward the ultrasonic transducer. The approach region increases the transit time of the transmitted acoustic pulses so that the transit time required by an acoustic pulse to travel through the acoustic guide conduit, to a minimal fluid level at which the fluid level can still be measured, and back to the ultrasonic transducer is long enough to reliably separate the decaying generated acoustic pulse from its reflected acoustic pulse, its echo.

It is particularly advantageous if, adjoining the approach region, the acoustic guide conduit has at least one bend with a deflection and at least one straight region with a conduit slope angle since this allows the transit time of the transmitted acoustic pulses to be adapted to the geometry of the respective fuel tank. This is necessary since modern fuel tanks are produced in a wide variety of designs. The fluid level is determined based on the transit time of the acoustic pulse and a fluid volume is determined by means of a characteristic curve stored in an evaluation unit. The geometry of the fuel tank can result in an unfavorably steep slope of the characteristic curve. The steep slope of the characteristic curve reflects a low sensitivity in the measurement of the fluid level since a slight change in the transit time of the acoustic pulse represents a large change in the fluid volume. When the characteristic curve has a steep slope, this shortens the interval of transit time from the minimum measurable fluid level to the maximum fluid level, thereby reducing the measurement sensitivity and thus also the measurement precision. Varying the number of bends, the number of straight regions, and the angle of the deflection at each bend and varying the conduit slope angle of each straight region of the acoustic guide conduit makes it possible, for example, to adapt the transit time of the transmitted acoustic pulses and therefore the slope of the characteristic curve in such a way as to produce the highest possible sensitivity over the entire range of the fluid volume and therefore a low slope of the characteristic curve. A high degree of sensitivity is required particularly at low fluid levels so that a driver of a motor vehicle receives a precise and reliable indication of the fluid level.

It is also advantageous to place the ultrasonic transducer of the device on a side wall so as not to reduce the ground clearance of the motor vehicle. This is particularly relevant with regard to the danger of the vehicle undercarriage coming into contact with bumps in the road and thus damaging the ultrasonic transducer.

It is also advantageous to place the ultrasonic transducer outside the fuel tank. This makes it possible to use a particularly inexpensive ultrasonic transducer since it does not require a costly, fuel-resistant material and/or does not need to be sealed or encapsulated in order to protect it from the fuel.

It is also advantageous to use an ultrasonic transducer that is both a transmitter and receiver and is therefore particularly inexpensive and simplifies the device.

It is also advantageous to use an ultrasonic transducer in which the transmitter and receiver are separate from each other. In this exemplary embodiment, it is possible to eliminate the approach region.

It is advantageous if the acoustic guide conduit has at least one reference reflection surface since this makes it possible for disturbance influences such as the temperature of the fuel, which influences the speed of sound and consequently the transit time of the acoustic pulses, to be subsequently compensated for in an evaluation unit.

It is also advantageous if the acoustic guide conduit has at least two openings so that fuel can flow into the acoustic guide conduit and can assume the same fluid level as in the fuel tank. These openings assure a pressure balancing between the acoustic guide conduit and the fuel tank.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a sectional view of the device for measuring a fluid level, with an acoustic guide conduit that is bent at a 90 degree angle,

FIG. 2 shows a sectional view of the device, with a bent acoustic guide conduit that extends at an oblique angle,

FIG. 3 shows a sectional view of the device, with an acoustic guide conduit that has a number of bends,

FIG. 4 shows a sectional view of the device, with a bent acoustic guide conduit that extends at an oblique angle, without an approach region,

FIG. 5 shows a sectional view of the device, with an ultrasonic transducer disposed inside the fuel tank, and

FIG. 6 shows a characteristic curve that represents the fluid volume of the fuel tank as a function of the transit time.

### DESCRIPTION OF THE PREFERRED EMBODIMENTS

Although the device is especially useful for measuring a fluid level in a fuel tank of a motor vehicle, the device is expressly not limited to such use in a fuel tank. The device can be used to measure the fluid level of any fluid in any kind of container. In addition, the device can also be used to determine the fluid volume of the fuel tank.

The device is comprised of an acoustic guide conduit 2 disposed in a container 1, for example a fuel tank 1, and an ultrasonic transducer 3 provided outside the fuel tank 1. The fuel tank 1 contains fuel as the fluid, filled to a fluid level 4. The fuel in the fuel tank 1 has a fluid volume V. At the height of the fluid level 4, the fuel level 5 is a boundary surface between the fuel and an empty volume 8 above it, which is filled with a gas mixture, for example comprised of air and evaporated fuel.

The fuel tank 1 can have any form and can be embodied, for example, as a saddle tank or as a multi-chambered tank.

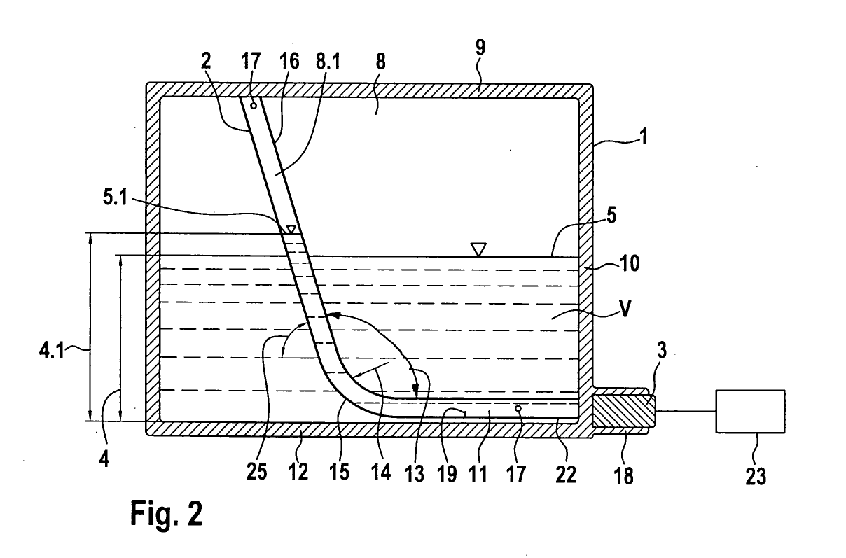

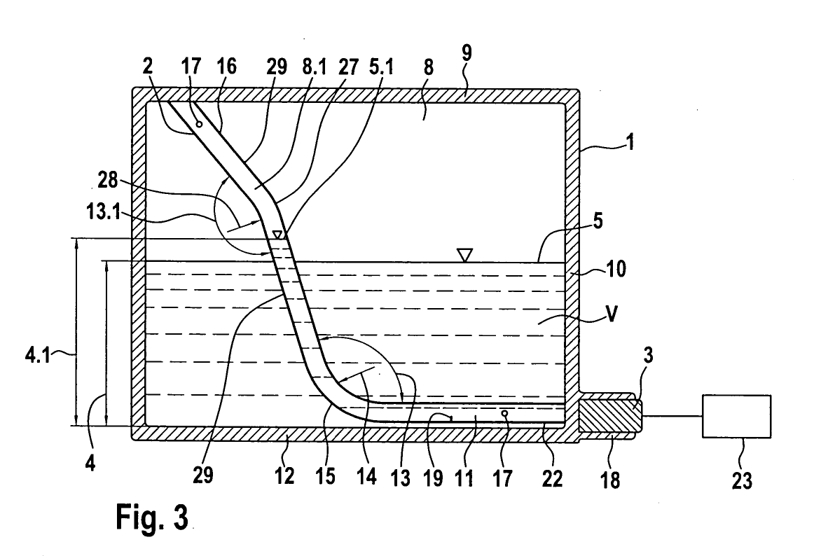

The acoustic guide conduit 2 is disposed inside the fuel tank 1. One end of the acoustic guide conduit 2 is disposed against the inside of a cover wall 9 of the fuel tank 1 and the other end is disposed against the inside of a side wall 10 of the fuel tank 1. For example, the acoustic guide conduit 2 is glued, molded, or welded to the cover wall 9 and to the side wall 10. The acoustic guide conduit 2 has a round cross section, for example, with an inner diameter that is less than one centimeter. For example, the inner diameter may be five millimeters. The cross section of the acoustic guide conduit 2, however, can also be any shape such as oval or polygonal. Starting from the end disposed against the inside of the side wall 10 and directed into the inside of the fuel tank 1, in an approach region 11, the acoustic guide conduit 2 extends for example in a straight line in the same horizontal direction as a container bottom 12. The approach region 11, however, can also be coiled by means of bends or can be provided at an oblique angle, with a slope. Adjoining the approach region 11, the acoustic guide conduit 2 has a measurement tube region 16. The measurement tube region 16 has a first bend 15 adjoining the approach region 11, with a bending radius 14 and a deflection 13. The deflection 13 is for example ninety degrees, but can also be less than or greater than ninety degrees, as shown for example in FIGS. 2 and 3. In the text below, the term deflection 13 is always understood to be an angle. After the first bend 15 of the measuring tube region 16, the measuring tube region 16 extends for example in a straight line in the same direction as the side wall 10, but can also extend at an oblique angle to the side wall 10.

In the vicinity of each of the two ends of the acoustic guide conduit 2, a respective opening 17 is provided in the wall of the acoustic guide conduit 2. However, a multitude of openings 17 can also be provided that are disposed distributed over the entire length of the acoustic guide conduit 2 and simultaneously function as filters that prevent impurities from flowing into the acoustic guide conduit 2. For example, the openings 17 can be round, oval, rectangular, or polygonal. The acoustic guide conduit 2 contains fuel at a fluid level 4.1. At the same height as a fluid level 4.1, the fuel level 5.1 is the boundary surface between the fuel and an empty volume 8.1 above it, which is filled with a gas mixture, for example comprised of air and evaporated fuel.

The acoustic guide conduit 2 comprised of the approach region 11 and the measurement tube region 16 is embodied for example in one piece and is made for example of plastic, but can also be made of metal.

The end of the acoustic guide conduit 2 disposed against the inside of the side wall 10 and the approach region 11 are disposed as close as possible to the inside of the container bottom 12. The ultrasonic transducer 3 is disposed close to the container bottom 12, on the outside of the side wall 10, opposite from the end of the acoustic guide conduit 2 disposed against the inside of the side wall 10. The ultrasonic transducer 3 rests against the outside of the side wall 10 and is fastened, for example, to a socket 18 provided on the fuel tank 1, for example is clipped, screwed, or glued into this socket 18. The side wall 10 is disposed between the ultrasonic transducer 3 and the end of the acoustic guide conduit 2.

In the approach region 11 and inside the acoustic guide conduit 2, a reference reflection surface 19 is provided, which is for example planar and protrudes partially into the acoustic guide conduit 2 in a lateral direction. The reference reflection surface 19 can, however, also be nonplanar and can protrude partially into the acoustic guide conduit 2 in any direction. For example, it is of one piece with the acoustic guide conduit 2. The reference reflection surface 19 can, for example, also be a conduit that protrudes into the acoustic guide conduit 2, serves as an opening 17, and reflects an acoustic pulse. It is also possible for a number of reference reflection surfaces 19 to be provided in the acoustic guide conduit 2, both in the approach region 11 and in the measuring tube region 16.

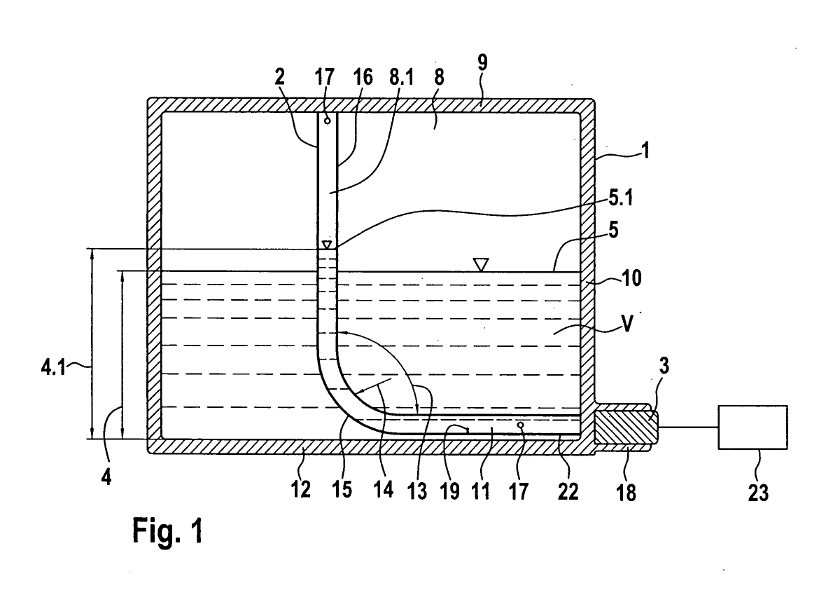

Fuel can flow into and out of the acoustic guide conduit 2 through the openings 17. This occurs whenever the fluid level 4 and the fluid level 4.1 are at different heights. If the fluid level 4 is higher than the fluid level 4.1, for example after refilling the fuel tank 1, then fuel flows into the acoustic guide conduit 2 through the openings 17 disposed below the fuel level 5. If the fluid level 4.1 is higher than the fluid level 4, for example due to consumption of the fuel by an internal combustion engine, then fuel flows in the reverse direction from the acoustic guide conduit 2 into the fuel tank 1. In FIGS. 1 to 5, the fluid level 4.1 is depicted out of equilibrium in order to distinguish it from the fluid level 4, so that the fluid level 4.1 is shown as higher than the fluid level 4 for example. The exchange of fuel between the fuel tank 1 and the acoustic guide conduit 2, however, always produces an equilibrium after a certain time, with equal fluid levels 4 and 4.1 as long as the fluid level 4 is above the lowest opening 17 with reference to the container bottom 12. The volume of the fuel flowing into the acoustic guide conduit 2 displaces gas that flows out of the acoustic guide conduit 2 into the fuel tank 1 through the openings 17 disposed above the fuel level 5. By contrast, gas also flows into the acoustic guide conduit 2 through the openings 17 disposed above the fuel level 5 when fuel flows out of the acoustic guide conduit 2. The openings 17 thus permit a pressure balancing between the fuel tank 1 and the acoustic guide conduit 2 both in terms of the liquid fuel and in terms of the gas. If the fuel level 5 falls below the lowest opening 17 with reference to the container bottom 12, then fuel can no longer flow into the acoustic guide conduit 2.

The acoustic guide conduit 2 reduces or smoothes out the changes in the fluid level 4.1 caused by sloshing motions since the fluid level 4.1, due to the fuel exchange between the fuel tank 1 and the acoustic guide conduit 2 through the openings 17, gradually adapts to the fluid level 4 after an initial delay. As a result, the measured fluid volume V of the fuel is distorted less severely than in conventional devices by sloshing movements in the fuel tank 1 that can occur, for example, when a vehicle accelerates or negotiates a curve.

The ultrasonic transducer 3 is embodied, for example, as a pulse echo sensor, which cyclically generates and emits short acoustic pulses and measures a transit time t between the instant the pulse is emitted and the instant the reflected acoustic pulse, the so-called echo, returns. A different sensor can also be used, however, which for example generates and emits acoustic waves continuously and in this case, instead of determining the transit time t, a phase shift is measured between the emitted and the reflected acoustic waves. The ultrasonic transducer 3 is for example a transmitter and receiver at the same time. However, an ultrasonic transducer can also be used in which the transmitter and the receiver are spaced apart from each other.

The acoustic pulse generated by the ultrasonic transducer 3 is transmitted to the side wall 10 with a predetermined intensity and from there is transmitted mainly to the fuel in the acoustic guide conduit 2. The acoustic pulse propagates in the fuel at the speed of sound in the direction of the acoustic guide conduit 2, is transmitted through the conduit wall 22 of the acoustic guide conduit 2, and finally strikes the fuel level 5.1 and is reflected there. The reflected acoustic pulse then moves in the opposite direction back to the ultrasonic transducer 3 and propagates at the speed of sound in the direction of the acoustic guide conduit 2. The reflected acoustic pulse strikes the side wall 10, passes through it, and then strikes the ultrasonic transducer 3, which detects the reflected acoustic pulse and registers the transit time t of the acoustic pulse.

It is important that the transit time t of the acoustic pulse not be too short, thus causing the reflected acoustic pulse to return to the ultrasonic transducer 3 in too short a time since in this case, the ultrasonic transducer 3 is still in the process of dying down to stillness with its characteristic decay duration from the last acoustic pulse generated and is not yet ready to detect the echo. However, in order to prolong the transit time particularly at low fluid levels 4, the acoustic guide conduit 2 is provided with the horizontally extending approach region 11, which extends the path of the acoustic pulse to the fuel level 5.1. With the addition of the approach region 11, the transit time t needed for an acoustic pulse to travel through the acoustic guide conduit 2 to a minimal fill level 4 that can still be measured and back to the ultrasonic transducer 3 is long enough to reliably separate the decaying generated acoustic pulse from the reflected acoustic pulse, i.e. its echo. The length of the approach region 11 thus depends on a minimum transit time that the ultrasonic transducer 3 needs in order to die down to stillness so that it can then reliably detect the reflected acoustic pulse.

The transit time t of the acoustic pulse must not be too long since the intensity of the acoustic pulse decreases as the transit time increases. If the intensity of the acoustic pulse is too low, then the ultrasonic transducer 3 can no longer detect the reflected acoustic pulse.

The emitted acoustic pulse is reflected against the conduit wall of the first bend 15 and against that of the additional bends 27. The bending radius 14, 28 must be of sufficient magnitude that the acoustic pulse is reflected toward the fluid level 5.1 and travels back in this direction. By contrast, with an insufficient bending radius 14, 28, the acoustic pulse is reflected toward the ultrasonic transducer 3 and travels back to the ultrasonic transducer 3 so that an erroneous transit time measurement occurs.

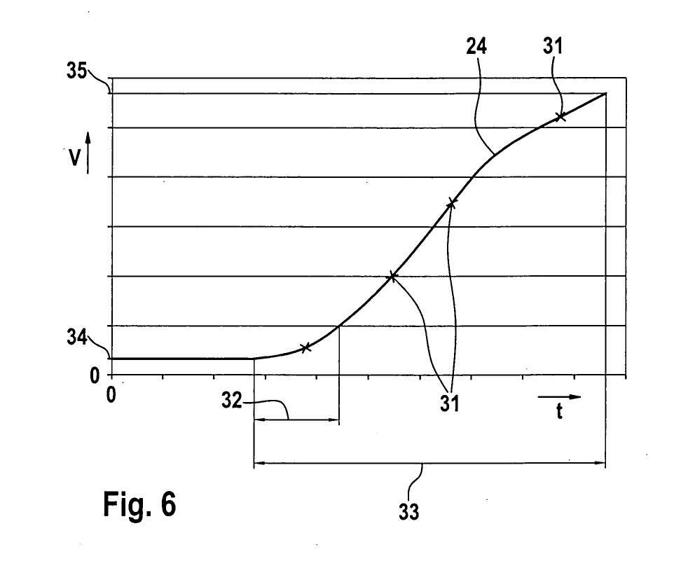

The fluid level 4 is determined from the product of the transit time and the speed of sound. The fluid volume V is determined based on a characteristic curve 24 (FIG. 6) stored in an evaluation unit 23.

The device according to the invention can measure the fluid volume V of the fuel tank 1 down to a minimum fluid level 4 by means of the ultrasonic transducer 3. The minimum fluid level 4 depends on how close the acoustic guide conduit 2 is to the inside of the container bottom 12 and also depends on the size of the cross section of the acoustic guide conduit 2 and on the position of the lowest opening 17 in relation to the container bottom 12 since the transit time can only be reliably measured if the approach region 11 is at least partially filled with fuel. The higher the acoustic guide conduit 2 is in relation to the container bottom 12, the higher the lowest opening 17 is disposed in relation to the container bottom 12, and the larger the cross section of the acoustic guide conduit 2, the higher the fuel level 5 must rise before the fuel can flow into the acoustic guide conduit 2 via the lowest opening 17 in relation to the container bottom 12 and the minimal fluid level 4 is reached. The fluid volume V cannot be measured below the minimum fluid level 4. Clearly, the minimum fluid level 4 at which a fluid volume V can be measured should be as low as possible. Therefore the acoustic guide conduit 2 must be disposed as close as possible to the container bottom 12 and therefore the cross section of the acoustic guide conduit 2 should be selected as correspondingly small.

The cross section of the acoustic guide conduit 2 is preferably selected as small enough that the fuel level 5.1 assumes a dome shape due to the surface tension of the fuel. As a result, the fuel level 5.1 does not assume an oblique inclination. If the fuel level 5 of the fuel tank 1 is inclined, i.e. is not parallel to the container bottom 12, for example when driving uphill or downhill, then the fuel level 5.1 in the acoustic guide conduit 2 still retains its dome shape and the measurement of the transit time t is not hindered by an inclined fuel level 5.1.

The reference reflection surface 19 serves to reduce or compensate for influences, so-called disturbance influences, such as the temperature and pressure of the fuel, that impair the measurement of the fluid volume V. The acoustic pulse that is reflected against the reference reflection surface 19 is referred to as the reference echo. The transit time of the reference echo is known as soon as it has been measured once at a particular temperature and a particular pressure and is stored, for example, in the evaluation unit 23. In addition, a distance to be traveled by an acoustic pulse between the reference reflection surface 19 and the ultrasonic transducer 3 is known and stored, for example, in the evaluation unit 23. The transit time of acoustic pulses depends on the speed of sound in the fuel. The speed of sound in the fuel depends on the temperature and pressure of the fuel. Comparing the transit time of a reference echo stored in the evaluation unit 23 to the transit time of a reference echo that is measured during a fluid level measurement makes it subsequently possible for the evaluation unit 23 to mathematically correct for disturbance influences such as a change in the temperature, the pressure, or the density of the fuel. A fluid level measurement that is corrected in this manner is virtually independent of the temperature and pressure. The bending radius 14 of the first bend 15 must not be excessively small in order not to negatively impact the guidance of the acoustic pulses in the direction of the fuel level 5.1. An excessively small bending radius 14 results in an at least partial reflection of the acoustic pulse against the conduit wall 22 back toward the ultrasonic transducer 3 so that an undesirable additional echo occurs and at the very least, the acoustic pulse reflected against the fuel level 5.1 turns out to be very weak.

The ultrasonic transducer 3 does not have to be disposed on the side wall 10, but can also be disposed on the container bottom 12.

In addition to measuring the fluid level, the device according to the invention can also perform other functions. For example, the device can be used to detect the presence of water in the fuel tank. Water is frequently present in diesel fuel, for example, and due to its higher density, collects at the container bottom 12 and also gets into the acoustic guide conduit 2 through the openings 17. Between the water and the fuel, a separation layer forms that reflects the acoustic pulses, thus generating an additional echo. This additional echo indicates the presence of a water layer at the container bottom 12. By evaluating the transit times of a number of reference echoes of the reference reflection surface 19, the evaluation unit 23 can find or detect the correct echo that relates to the boundary layer between the fuel and the gas.

By evaluating the transit times of the reference echo with the aid of the evaluation unit 23, it is also possible to calculate and test fuel properties such as the density of the fuel. In order to do so, it is also necessary to know the temperature and the pressure in the fuel tank 1.

In the device according to FIG. 2, parts that are the same or function in the same manner as those in the devices in FIG. 1 are provided with the same reference numerals.

FIG. 2 shows a sectional view of the device according to the invention, with a bent acoustic guide conduit 2 that extends at an oblique angle. The device according to FIG. 2 differs from the device according to FIG. 1 in that the measurement tube region 16 after the first bend 15 extends at an oblique angle with a conduit slope, i.e. does not extend in the same direction as the side wall 10. The deflection 13 of the first bend 15 is for example greater than ninety degrees. Changing the deflection 13 and the conduit slope influences the transit time of an emitted acoustic pulse and thus varies the slope of the characteristic curve 24 in FIG. 6, making it possible to adjust the sensitivity of the measurement of the fluid volume V. Since modern fuel tanks are produced in a wide variety of designs, some of them with very complex forms, it is necessary to adapt the transit time of an emitted acoustic pulse through the design of the measurement tube region 16 of the acoustic guide conduit 2, for example by changing the conduit slope or the deflection 13 so that a sufficient sensitivity is achieved for every fluid level 4. The conduit slope is defined by the tangent of the fuel inclination angle 25. The lower the conduit slope, the longer the path from the ultrasonic transducer 3 to the fuel level 5.1 and therefore also the longer the transit time t of the emitted acoustic pulse.

In the device according to FIG. 3, parts that are the same or function in the same manner as those in the devices in FIGS. 1 and 2 are provided with the same reference numerals.

FIG. 3 shows a sectional view of the device according to the invention, with an acoustic guide conduit that has a number of bends. The device according to FIG. 3 differs from the device according to FIG. 2 in that in addition to the first bend 15, the measurement tube region 16 has at least one additional bend 27 with a bending radius 28 and a deflection 13.1 directed away from the ultrasonic transducer 3. The bending radius 28 of the additional bend 27 also must not be too small so that it does not negatively impact the guidance of the acoustic pulses in the direction of the fuel level 5.1. The deflection 13.1 is arbitrary as long as the conduit slope is positive and the acoustic guide conduit 2 extends toward the cover wall 9. An excessively small bending radius 28 results in an at least partial reflection of the acoustic pulse against the conduit wall 22 so that an undesirable additional echo occurs and at the very least, the acoustic pulse reflected against the fuel level 5.1 turns out to be very weak. In addition to the first bend 15, the measurement tube region 16 can be provided with an arbitrary number of additional bends 27. Before and after an additional bend 27, a region 29 can be provided that extends in a straight line and has a conduit slope. This is not absolutely required, though. Due to the presence of the additional bend 27, two adjacent regions 29 extending in a straight line have different conduit slopes from each other.

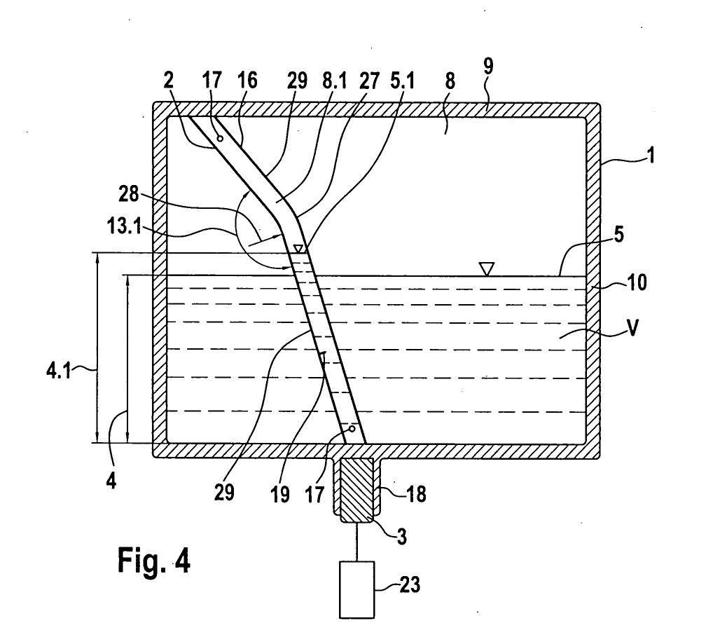

In the device according to FIG. 4, parts that are the same or function in the same manner as those in the devices in FIGS. 1 to 3 are provided with the same reference numerals.

FIG. 4 shows a sectional view of the device according to the invention, with a bent acoustic guide conduit. The device according to FIG. 4 differs from the device according to FIG. 3 in that the approach region 11 and the first bend 15 of the measurement tube region 16 have been eliminated and the ultrasonic transducer 3 is disposed outside the fuel tank 1 on the outside of the container bottom 12. The elimination of the approach region 11 produces the measurement imprecision at low fluid levels that has already been described above. However, the transit time t of the acoustic pulses can be adapted by means of at least one additional bend 27, the degree of the deflection 13, and the conduit slope so that a high degree of sensitivity is produced at the remaining fluid levels.

Positioning the ultrasonic transducer 3 outside the container bottom 12, however, reduces the ground clearance, i.e. the distance between the container bottom 12 of the vehicle and a road surface. As a result, when passing over an obstacle, for example a bump in the road, the vehicle comes into contact with the road surface sooner than a vehicle in which the ultrasonic transducer 3 is not disposed on the outside of the container bottom 12. There is also the danger of the ultrasonic transducer 3 being damaged or even destroyed when it comes into contact with the obstacle. The ultrasonic transducer 3 is better protected from damage when it is disposed on the side wall 10.

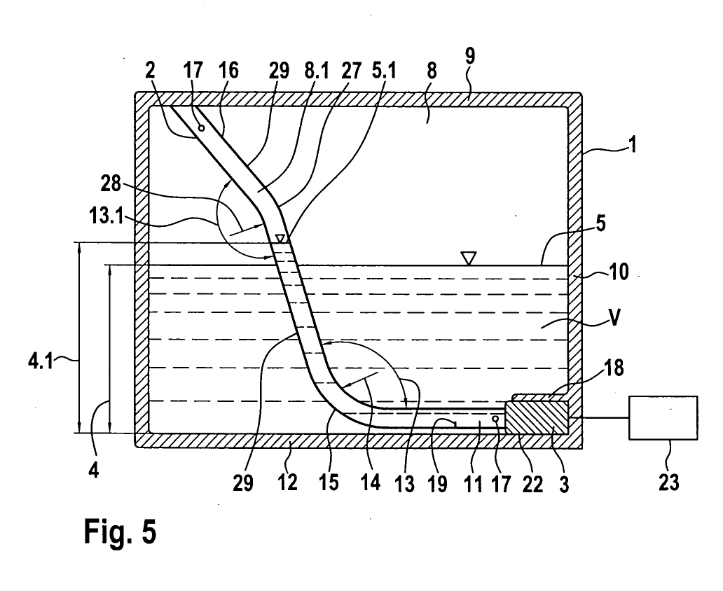

In the device according to FIG. 5, parts that are the same or function in the same manner as those in the devices in FIGS. 1 to 4 are provided with the same reference numerals.

FIG. 5 shows a sectional view of the device according to the invention, with an ultrasonic transducer disposed inside the fuel tank. The device according to FIG. 5 thus differs from the device according to FIG. 3 in that the ultrasonic transducer is contained inside the fuel tank 1.

The ultrasonic transducer 3 can also be provided inside the fuel tank 1, close to the container bottom 12. For example, the ultrasonic transducer 3 is disposed against the inside of the side wall 10. However, this requires that the ultrasonic transducer 3 be sealed to protect it from the fuel and be made of a fuel-resistant material. The ultrasonic transducer 3 can also be disposed so that it is integrated into the acoustic guide conduit 2.

FIG. 6 shows the characteristic curve 24 of the device according to the invention, with the fluid volume V on the ordinate and the transit time t on the abscissa.

The characteristic curve 24 represents the fluid volume V as a function of the transit time t. The characteristic curve 24 is experimentally determined by measuring the corresponding transit time t for known fluid volumes V contained in the fuel tank. This yields a transit time interval 33 that includes all of the transit times t from the minimum measurable fluid volume 34 to the maximal fluid volume 35 of the fuel tank 1. The characteristic curve 24 is then stored in the evaluation unit 23, for example by means of number of checkpoints 31, so that for each transit time t, an associated fluid volume V can be calculated. The slope of the characteristic curve 24 corresponds to a sensitivity of the measurement. A low slope of the line 24 indicates a high sensitivity since even a small change in the fluid volume V produces a large change in the transit time t. A low conduit slope of the acoustic guide conduit 2, due to the long transit times t, also results in a low slope of the characteristic curve 24 and therefore to a high sensitivity. The longer the transit time interval 33 for a fixed fluid volume V, the flatter the slope of the characteristic curve is and the higher a resolution and sensitivity of the measurement value are with regard to the fluid level.

Since the driver of the vehicle should be furnished with very precise information about the fluid level in the fuel tank when the fluid level 4 is low, the characteristic curve 24 must have a high sensitivity and therefore a low slope in a residual quantity region 32 in which fluid volumes V are low and transit times t are short. For this reason, the acoustic guide conduit 2 has a low conduit slope close to the container bottom 12.

Varying the number of bends 27 and/or the number of straight regions 29 and/or the conduit slope of the straight regions 29 of the measurement tube region 16 and/or of the deflection 13 and 13.1 thus permits the sensitivity of the measurement of the fluid level to be adapted to the respective form or geometry of the fuel tank 1 over the entire range of the fluid volume V.

The foregoing relates to preferred exemplary embodiments of the invention, it being understood that other variants and embodiments thereof are possible within the spirit and scope of the invention, the latter being defined by the appended claims.

We claim:

1. In a device for measuring a level of a fluid in a container with a container bottom, in particular in a fuel tank of a motor vehicle, with an acoustic guide conduit provided in the container and with at least one ultrasonic transducer disposed close to one end of the acoustic guide conduit for generating ultrasonic pulses and for receiving the ultrasonic pulses reflected in the region of a fluid level in the container, the improvement wherein the acoustic guide conduit (2) comprises a horizontal or inclined approach region (11) disposed close to the container bottom (12).

2. The device according to claim 1, wherein the approach region (11) extends in a straight line or is coiled.

3. The device according to claim 1, wherein the ultrasonic transducer (3) is disposed on a side wall (10) of the container (1).

4. In a device for measuring a level of a fluid in a container with a container bottom, in particular in a fuel tank of a motor vehicle, with an acoustic guide conduit provided in the container and with at least one ultrasonic transducer disposed close to one end of the acoustic guide conduit for generating ultrasonic pulses and for receiving the ultrasonic pulses reflected in the region of a fluid level in the container, the improvement wherein the acoustic guide conduit (2) comprises at least one bend (15, 27) with a respective deflection (13, 13.1) and/or at least one straight region (29) with a conduit slope angle (25).

5. The device according to claim 4, wherein the ultrasonic transducer (3) is disposed at a container bottom (12) of the container (1).

6. The device according to claim 1, wherein the ultrasonic transducer (3) is disposed outside the container (1).

7. The device according to claim 4, wherein the ultrasonic transducer (3) is disposed outside the container (1).

8. The device according to claim 1, wherein the ultrasonic transducer (3) is disposed inside the container (1).

9. The device according to claim 4, wherein the ultrasonic transducer (3) is disposed inside the container (1).

10. The device according to claim 1, wherein the ultrasonic transducer (3) is a transmitter and receiver at the same time.

11. The device according to claim 4, wherein the ultrasonic transducer (3) is a transmitter and receiver at the same time.

12. The device according to claim 1, wherein the acoustic guide conduit (2) has at least one reference reflection surface (19).

13. The device according to claim 4, wherein the acoustic guide conduit (2) has at least one reference reflection surface (19).

14. The device according to claim 1, wherein the acoustic guide conduit (2) has at least two openings (17).

15. The device according to claim 4, wherein the acoustic guide conduit (2) has at least two openings (17).
